(19) United States
(12) Patent Application Publication
(10) Pub. No.: US 2007/0135976 A1
(43) Pub. Date: Jun. 14, 2007

(54) Method for determining optimal drive point in series and parallel type hybrid car

(75) Inventor: Joon-Young Park, Seoul (KR)

Correspondence Address: EDWARDS ANGELL PALMER & DODGE LLP, P.O. BOX 55874, BOSTON, MA, 02205, US

(73) Assignee: Hyundai Motor Company, Seoul (KR)

(21) Appl. No.: 11/591,358

(22) Filed: Oct. 31, 2006

(30) Foreign Application Priority Data
Dec. 14, 2005 (KR) 10-2005-0123453

(51) Int. Cl. G06F 17/00

(52) U.S. Cl. 701/22; 701/54; 180/65.3

(57) ABSTRACT

A method for determination of an optimal drive point in a series/parallel hybrid car is provided, which comprises the steps of: (a) determining a target engine speed and a target engine torque based on a torque, a car speed and a battery power required for the series/parallel hybrid car; (b) controlling the target engine torque by an engine controller and controlling the target engine speed by controlling the speed of a generator; and (c) compensating for the difference between the required torque and the torque directly outputted from an engine by using a motor torque.

### CROSS-REFERENCE TO RELATED APPLICATIONS

The present application claims priority of Korean Patent Application Serial Number 10-2005-123453, filed on Dec. 14, 2005, in the Korean Intellectual Property Office, the disclosure of which is hereby incorporated by reference herein in its entirety.

### FIELD OF THE INVENTION

The present invention relates to a method for determination of an optimal drive point in a series/parallel hybrid car, which can improve the efficiency of the entire system.

### BACKGROUND

It is well known in the art that a hybrid car employs at least two types of power sources. Generally, the hybrid car empolys an internal combustion engine and an electric motor.

The hybrid cars are classified into the following three types: series, parallel, and series/parallel. In a series hybrid car, as shown in FIG. 1, the power generated by an engine 11 is entirely converted into electric power by a generator 12, and the car is driven by a motor 13. Therefore, in a series hybrid car, it is possible to run the engine 11 at a maximum efficiency point independently of the traveling conditions. Also, the car can move while the engine 11 is not running. In addition, it is possible to charge the car while the car stops. However, in the series hybrid car, substantial amount of power transmission loss occurs in the course of converting mechanical power of the engine 11 into electrical power and converting electrical power into mechanical power.

In a parallel hybrid car, as shown in FIG. 2, due to the fact that an engine 11 is mechanically connected to a drive shaft, power transmission loss occurrs less than in a series hybrid car. Also, a motor generator 16 and a transmission 17 support the engine 11 so that the engine 11 can be run at a high efficiency. The degree of freedom of the parallel hybrid car, however, is less than that of a series hybrid car.

In a series/parallel hybrid car, as shown in FIG. 3, one engine 20 and two motor generators 21, 22 are connected with each other by planetary gears 23, and the power of the engine 20 is transmitted mechanically (in parallel) and electrically (in series) to an axle.

In the series/parallel hybrid car, because electric power transmission efficiency is significantly lower than mechanical power transmission efficiency, it is important not only to develop an engine with high power but also to increase the efficiency of power transmission. However, in the course of development of series/parallel hybrid cars, researchers and engineers have neglected the importance of power transmission efficiency while they have focused only on the development of high power engines.

There is thus a need for series/parallel hybrid cars having an engine system with a high efficiency of power generation and power transmission as well.

The information disclosed in this Background section is only for enhancement of understanding of the background of the invention and should not be taken as an acknowledgement or any form of suggestion that this information forms the prior art that is already known to a person skilled in the art.

### SUMMARY OF THE INVENTION

In one aspect, a method for determination of an optimal drive point in a series/parallel hybrid car is provided, comprising the steps of: (a) determining a target engine speed and a target engine torque based on a torque, a car speed and a battery power required for the series/parallel hybrid car; (b) controlling the target engine torque by an engine controller and controlling the target engine speed by controlling generator speed; and (c) compensating for a difference between the required torque and the torque directly outputted from an engine by using a motor torque.

Preferably, the target engine speed and the target engine torque may be determined based on final input and output values such that highest engine efficiency and highest power transmission efficiency can be obtained.

In a preferred embodiment, a control map may be used to produce optimal engine drive points with respect to the required torque, car speed and battery power.

In another preferred embodiment, the target engine speed and the target engine torque may be determined by the following four state equations: (a) Te=(Tr−Tm)×(1+R)/R, (b) Te=−Tg×(1+R), (c) Wg=(1+R)×We−(R×Wm) and (d) Pme+Pge=Pb, wherein: Te refers to engine torque; Tm refers to motor torque; Tg refers to generator torque; Tr refers to torque required by a driver; We refers to engine speed; Wm refers to motor speed; Wg refers to generator speed; R refers to gear ratio of a planetary gear which is a constant; Pb refers to battery power; Pme refers to motor power which is represented by Pme=Wm×Tm×Nm when the motor is charged and is represented by Pme=Wm×Tm/Nm when discharged, wherein Nm is motor efficiency represented by Nm=fn(Tm,Wm); and Pge refers to generator power which is represented by Pge=Wg×Tg×Ng when charged and is represented by Pge=Wg×Tg/Ng when discharged, wherein Ng is generator efficiency represented by Ng=fn(Tg,Wg).

To obtain an optimal drive point from the four state equations, Te, Tm, Tg, We and Wg are used as control variables.

In another aspect, motor vehicles are provided that comprise an engine system having a high power generation and power transmission efficiency attained by a described method.

It is understood that the term “vehicle” or other similar term as used herein is inclusive of motor vehicles in general such as passenger automobiles, buses, trucks, various commercial vehicles, and the like.

Other aspects of the invention are discussed infra.

### BRIEF DESCRIPTION OF THE DRAWINGS

For a better understanding of the nature and objects of the present invention, reference should be made to the following detailed description with the accompanying drawings.

FIG. 1 is a view illustrating the construction of a conventional series hybrid car;

FIG. 2 is a view illustrating the construction of a conventional parallel hybrid car;

FIG. 3 is a view illustrating the construction of a conventional series/parallel hybrid car;

FIG. 4 is a diagram of illustrating an engine torque map and an engine speed map according to the present invention;

FIG. 5 is a conceptual diagram illustrating the procedure for determining the optimal drive point according to the present invention; and

FIG. 6 is a flow chart illustrating a method for determining the optimal drive point in a series/parallel hybrid car in accordance with an embodiment of the present invention.

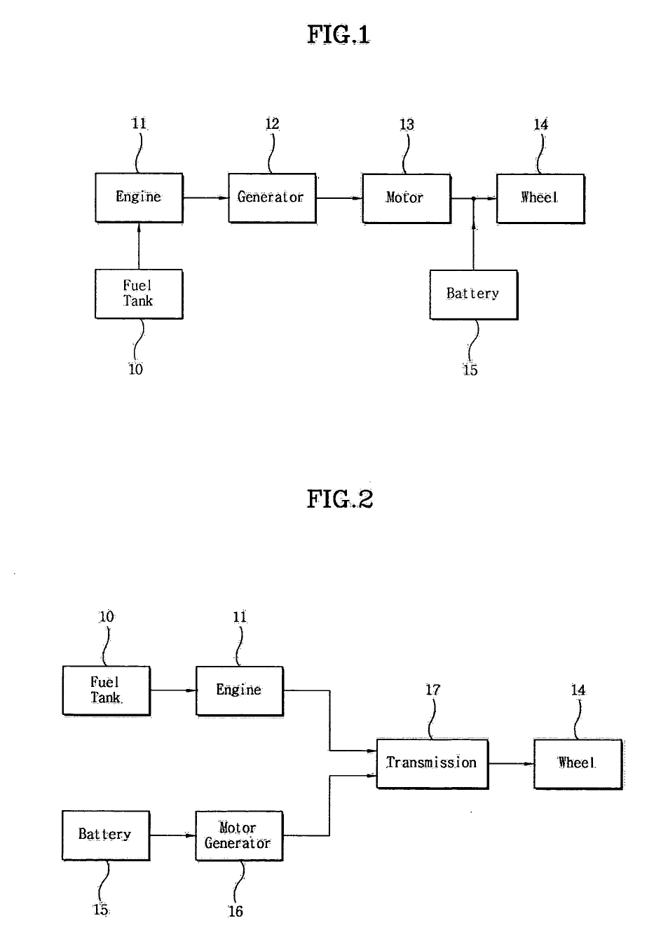

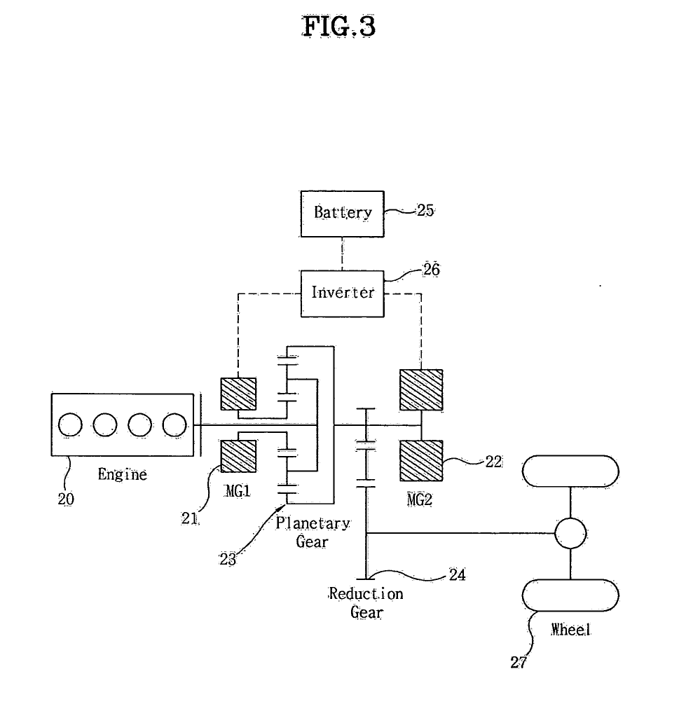

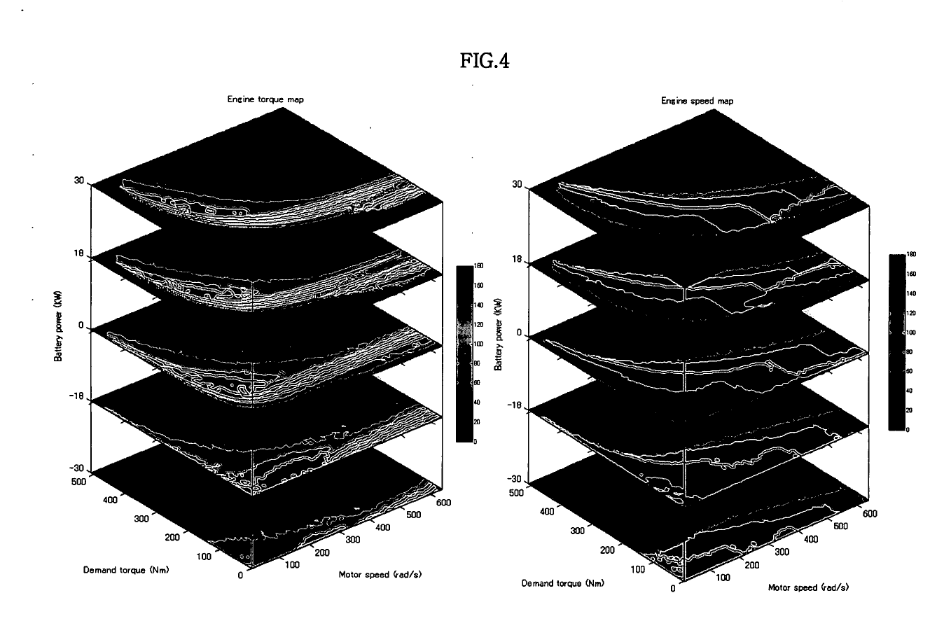

### DETAILED DESCRIPTION

As discussed above, in one aspect, a method for determination of an optimal drive point in a series/parallel hybrid car is provided, comprising the steps of: (a) determining a target engine speed and a target engine torque based on a torque, a car speed and a battery power required for the series/parallel hybrid car; (b) controlling the target engine torque by an engine controller and controlling the target engine speed by controlling a generator speed; and (c) compensating for a difference between the required torque and the torque directly outputted from an engine by using a motor torque.

Reference will now be made in greater detail to a preferred embodiment of the invention, an example of which is illustrated in the accompanying drawings. Wherever possible, the same reference numerals will be used throughout the drawings and the description to refer to the same or like elements.

In a preferred embodiment of the present invention, an optimal drive point ensuring high efficiency of an entire system can be obtained by using steady state equations for series/parallel hybrid cars.

The steady state equations used include two equations regarding mechanical torques, one equation regarding mechanical speeds, and one equation regarding electricity. The two equations regarding mechanical torques are Te=(Tr−Tm)×(1+R)/R and Te=−Tg×(1+R). The equation regarding mechanical speeds is Wg=(1+R)×We−(R×Wm). The equation regarding electricity is Pme+Pge=Pb.

Here, Te, Tm and Tg are engine torque, motor torque and generator torque, respectively. Tr is a driver's required torque. We, Wm and Wg are engine speed, motor speed and generator speed, respectively.

R is a gear ratio of a planetary gear, which is a constant.

Pb, Pme and Pge are battery power, motor power and generator power, respectively. When charged, Pme is represented by Pme=Wm×Tm×Nm, and when discharged, Pme is represented by Pme=Wm×Tm/Nm. Here, Nm is motor efficiency represented by Nm=fn(Tm,Wm).

Likewise, Pge is represented by Pge=Wg×Tg×Ng when charged, and by Pge=Wg×Tg/Ng when discharged. Here, Ng is generator efficiency represented by Ng=fn(Tg,Wg).

The above four state equations and eight variables Te, Tm, Tg, Tr, We, Wm, Wg and Pb are employed to produce an optimal drive point.

Meanwhile, a system efficiency can be represented by the ratio of a final output to a system input, which is Nsystem=Pout/Pin=(Wm×Tr+Pb)/Pfuel.

Among the eight variables, Wm, Tr and Pb, which correspond to final outputs, have already been determined, and there exist numerous sets of the five variables that satisfy the four equations.

As a consequence, to determine the optimal point of a minimum fuel consumption rate, a direct search method based on Pfuel=fn(We,Te)(BSFC) can be used. Since the final input and final output are used, the optimal drive point ensuring not only high engine efficiency but also high power transmission efficiency can be obtained.

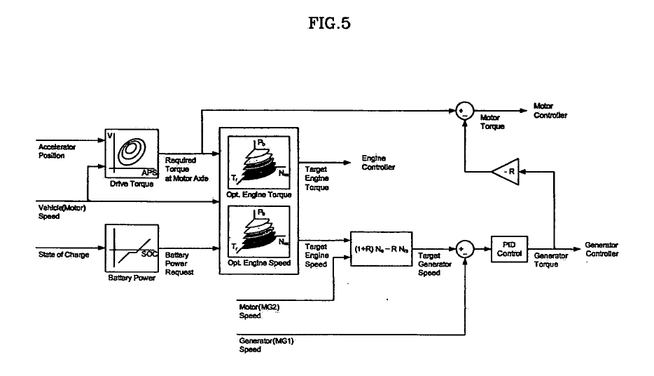

The optimal engine drive points for respective car speeds (We), required torques (Tr) and battery powers (Pb) are represented on a control map as shown in FIG. 4. An optimal engine speed and an optimal engine torque are stored for each car speed, required torque and battery power.

Then, by using the required torque, car speed, and battery power on the control map as shown in FIG. 5, target engine speed and target engine torque can be determined. The target engine torque can be controlled by using an engine controller. The target engine speed can be controlled by controlling the generator speed.

Also, the difference between the required torque and the torque (in parallel) directly outputted from the engine can be compensated by using motor torque. Since the engine torque is transmitted to a ring gear due to a reaction force of the generator, it is possible to determine the torque of a parallel path from the generator torque.

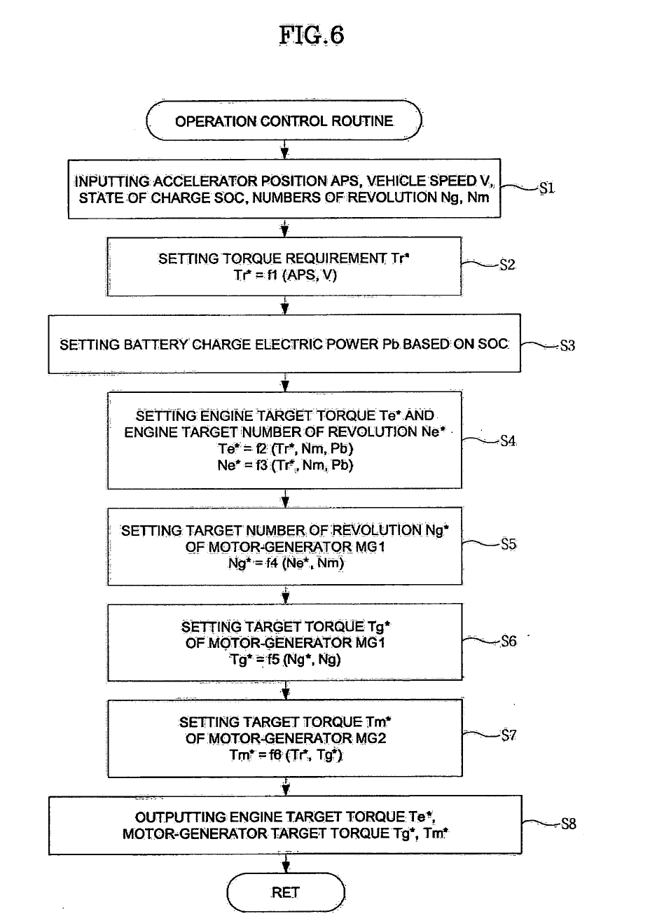

FIG. 6 shows an operation control routine. First, an accelerator position and a vehicle speed, a state of charge, numbers of revolutions of the motor and the generator are inputted (S1). A required torque is set (S2). A battery power is set based on the state of charge (S3).

Then, a target engine torque and a target number of engine revolutions are set (S4). A target number of revolutions of the motor generator is set (S5). After target torques of the motor generators are set (S6, S7), target engine torque and target motor generator torque are outputted (S8), which ensures high engine efficiency and power transmission efficiency, thereby keeping the efficiency of the entire system at its highest.

As is apparent from the above description, the method for determining the optimal drive point in series/parallel hybrid cars according to the present invention provides advantages in that, since the optimal drive point is determined in consideration of engine efficiency and power transmission efficiency, maximized efficiency of the entire system and remarkably improved fuel efficiency can be attained.

Although a preferred embodiment of the present invention has been described for illustrative purposes, those skilled in the art will appreciate that various modifications, additions and substitutions are possible, without departing from the scope and spirit of the invention as disclosed in the accompanying claims.

1. A method for determination of an optimal drive point in a series/parallel hybrid car, the method comprising the steps of:
(a) determining a target engine speed and a target engine torque based on a torque, a car speed and a battery power required for the series/parallel hybrid car;
(b) controlling the target engine torque by an engine controller and controlling the target engine speed by controlling a generator speed; and
(c) compensating for a difference between the required torque and the torque directly outputted from an engine by using a motor torque.

2. The method as set forth in claim 1, wherein the target engine speed and the target engine torque are determined based on final input and output values such that highest engine efficiency and highest power transmission efficiency can be obtained.

3. The method as set forth in claim 1, wherein optimal engine drive points with respect to the required torque, car speed and battery power are represented on a control map.

4. The method as set forth in claim 1, wherein the target engine speed and the target engine torque are determined by the following four state equations: (a) Te=(Tr−Tm)×(1+R)/R, (b) Te=−Tg×(1+R), (c) Wg=(1+R)×We−(R×Wm) and (d) Pme+Pge=Pb, wherein: Te refers to engine torque; Tm refers to motor torque; Tg refers to generator torque; Tr refers to torque required by a driver; We refers to engine speed; Wm refers to motor speed; Wg refers to generator speed; R refers to gear ratio of a planetary gear which is a constant; Pb refers to battery power; Pme refers to motor power which is represented by Pme=Wm×Tm×Nm when the motor is charged and is represented by Pme=Wm×Tm/Nm when discharged, wherein Nm is motor efficiency represented by Nm=fn(Tm,Wm); and Pge refers to generator power which is represented by Pge=Wg×Tg×Ng when charged and is represented by Pge=Wg×Tg/Ng when discharged, wherein Ng is generator efficiency represented by Ng=fn(Tg,Wg).

5. The method as set for in claim 4, wherein Te, Tm, Tg, We and Wg are used as control variables.

6. A motor vehicle comprising an engine system having high efficiency of power generation and power transmission obtained by the method of claim 1.
